(19) United States
(12) Patent Application Publication
(10) Pub. No.: US 2009/0091074 A1
(43) Pub. Date: Apr. 9, 2009

(54) Feeder and multifunction printer using the same

(75) Inventor: Ying-Hsien Kuo, Taipei (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/155,592

(22) Filed: Jun. 6, 2008

(30) Foreign Application Priority Data
Oct. 3, 2007 (TW) 96137152

(51) Int. Cl. B41F 13/00; B65H 7/00

(52) U.S. Cl. 271/117; 270/18

(57) ABSTRACT

A feeder and a multifunction printer using the same are provided. The feeder for moving a piece of paper includes a base, a housing, a cover and a driving mechanism. The base has a first surface for supporting the paper. The housing includes a frame and a holder. The frame is disposed over the base and has an opening that exposes part of the first surface. The holder for holding the paper is disposed over the frame, and a containing space is formed between the holder and the first surface. The cover is laid over one side of the housing. The driving mechanism is for driving the paper so as to move the paper from the holder to the first surface.

This application claims the benefit of Taiwan application Serial No. 96137152, filed Oct. 3, 2007, the subject matter of which is incorporated herein by reference.

### BACKGROUND OF THE INVENTION

1. Field of the Invention

The invention relates in general to a feeder and a multifunction printer using the same, and more particularly to a feeder capable of reducing the quantity of elements and a multifunction printer using the same.

2. Description of the Related Art

Of the computer peripheral commonly used in the office, conventional single-function devices such as facsimile machine, scanner, printer, and copier are gradually replaced by multifunction printer (MFP). Multifunction printer integrates various functions in a single machine, and can perform different kind of jobs which were originally done by different machines. For example, a multifunction printer can make a copy of a document, and at the same time e-mail the document. Such coordinate job can not be done by solely using a conventional facsimile machine or copier.

Normally, the multifunction printer includes a feeder, a flatbed scanning module, a communication module and a printing module. For facilitating the placement of the document, the feeder is normally liftably disposed on the flatbed scanning module. The feeder mainly includes a cover, a body, a roller assembly, a paper-feeding tray and a base. The cover is laid over the body, the roller assembly is disposed between the cover and the body, and the body is disposed on the base. The to-be-scanned document (in the form of a piece of paper for example) is placed on the paper-feeding tray, and is then fed into the cover by he roller assembly to perform scanning. After finishing the scanning process, the scanned paper is moved onto the body. On the other hand, when utilizing the flatbed scanning module to scan the paper, the feeder has to be lifted upwardly first, and then placing the paper on the flatbed scanning module. Afterwards, the feeder is laid back to the flatbed scanning module. In order to fix the paper, there is a paper-pressing element placed under the base of the feeder for pressing the paper onto the flatbed scanning module.

Recently, the market demand for low-price multifunction printers is increasing, yet the conventional way of constructing a multifunction printer by numerous elements can not effectively reduce the manufacturing cost. Moreover, during the manufacturing process, when these elements are assembled, the assembly tolerance is more likely to be increased, which can not effectively improve the assembly quality. Therefore, it is desirable to effectively reduce the quantity of elements used in the multifunction printer, so as to reduce the assembly tolerance and the manufacturing cost.

### SUMMARY OF THE INVENTION

The invention is directed to a feeder and a multifunction printer using the same. The base of the feeder holds and presses the paper at the same time, and the housing of the feeder is integrally formed in one piece. Therefore, the invention has the advantages of reducing the quantity of elements, simplifying structure and reducing cost.

According to a first aspect of the present invention, a feeder for moving a piece of paper is provided. The feeder includes a base, a housing, a cover and a driving mechanism. The base has a first surface for supporting the paper. The housing includes a frame and a holder. The frame is disposed over the base and has an opening that exposes part of the first surface. The holder for holding the paper is disposed over the frame, and a containing space is formed between the holder and the first surface. The cover is laid over one side of the housing. The driving mechanism is used for driving the paper, such that the paper is moved from the holder to the first surface.

According to a second aspect of the present invention, a multifunction printer including a body and a feeder is provided. The feeder for moving a piece of paper includes a base, a housing, a cover and a driving mechanism. The base is connected to the body and has a first surface for supporting the paper. The housing includes a frame and a holder. The frame is disposed over the base, and has an opening that exposes part of the first surface. The holder for holding the paper is disposed over the frame, and a containing space is formed between the holder and the first surface. The cover is laid over one side of the housing. The driving mechanism is used for driving the paper, such that the paper is moved from the holder to the first surface.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of a multifunction printer according to one embodiment of the invention; and

FIG. 2 is an exploded diagram of the multifunction printer of FIG. 1.

### DETAILED DESCRIPTION OF THE INVENTION

In the feeder and the multifunction printer using the same disclosed in the embodiment of the invention, two opposite surfaces of the base of the feeder are respectively used for supporting and pressing the paper, hence simplifying the design of the feeder. Besides, in the housing of the feeder, the part for holding the paper and the part for connecting to the base are integrally formed in one piece, hence reducing the quantity of elements of the feeder. One embodiment is disclosed below for elaborating the invention. The embodiment is for elaboration purpose, not for limiting the scope of protection of the invention. Besides, unnecessary elements are omitted in the diagrams of the embodiment to highlight the technical characteristics of the invention.

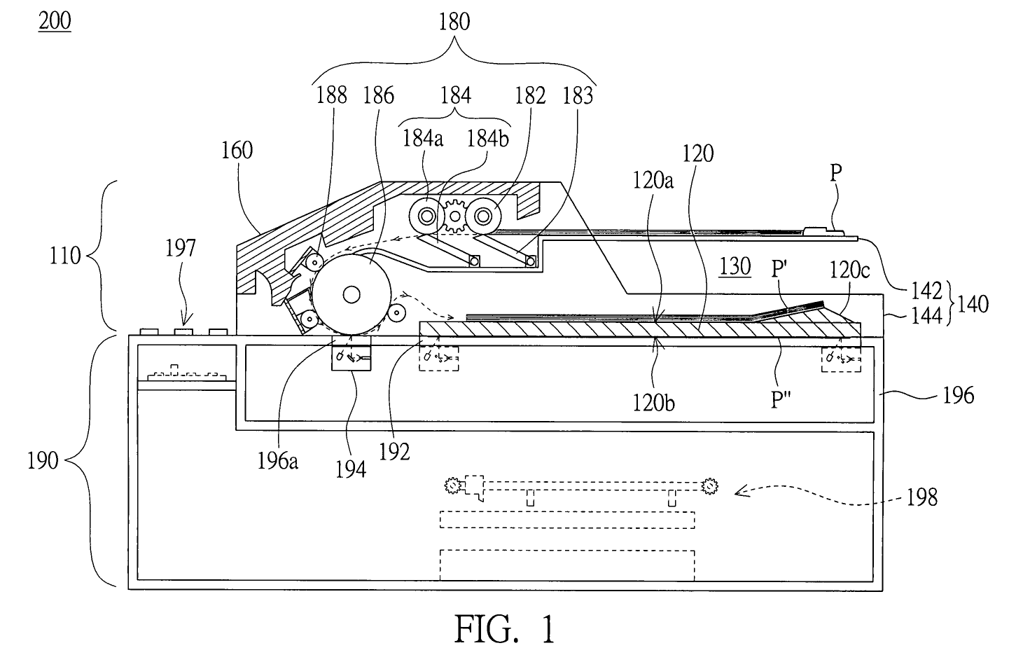

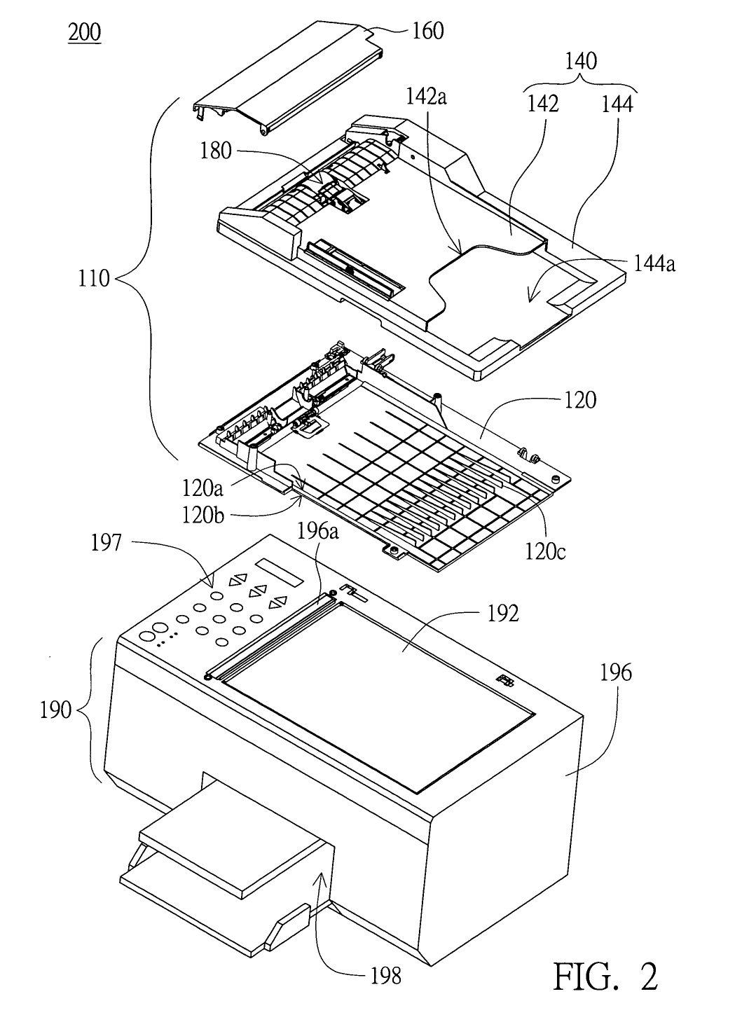

Please refer to both FIG. 1 and FIG. 2. FIG. 1 is a perspective of a multifunction printer according to a preferred embodiment of the invention. FIG. 2 is an exploded diagram of the multifunction printer of FIG. 1. The multifunction printer 200 includes a body 190 and a feeder 110. The feeder 110 for moving a piece of paper P includes a base 120, a housing 140, a cover 160 and a driving mechanism 180. The base 120 is disposed on the body 190, and has a first surface 120a for supporting the paper P′ that has been moved. The housing 140 includes a frame 144 and a holder 142. The frame 144 is disposed over the base 120 and has an opening 144a that exposes part of the first surface 120a. The holder 142 used for holding the paper P is disposed over the frame 144. There is a containing space 130 formed between the holder 142 and the first surface 120a. The cover 160 is laid over one side of the housing 140. The driving mechanism 180 is used for driving the paper P to move from the holder 142 to the first surface 120a. Preferably, the holder 142 and the frame 144 are integrally formed in one piece so as to reduce the quantity of elements of the feeder 110.

In the multifunction printer 200 of the invention, the moved paper P′ is directly placed on the first surface 120a. That is, the frame 144 does not need to contain the paper P, so the frame 144 is able to omit the plane of supporting the paper P. As indicated in FIG. 2, in the present embodiment of the invention, the frame 144 has an opening 144a which exposes the first surface 120a of the base 120, and the first surface 120a can be used as the plane of containing the paper P′. Therefore, the material cost of the frame 144 is reduced.

Besides, paper P″ is disposed on the body 190, and the base 120 further includes a second surface 120b for fixing the paper P″ on the body 190. Therefore, unlike the conventional feeder that requires a flat sponge and a plastic plate additionally disposed under the housing for pressing the paper, the feeder 110 can be constructed simply by three main elements, namely the cover 160, the housing 140 and the base 120. Generally, the quantity of elements in the multifunction printer 200 is then reduced, as well as the time and the cost for assembling the elements. Further, compared with the conventional multifunction printer which uses numerous elements, the multifunction printer 200 of the present embodiment of the invention only uses three elements, further decreasing the assembly tolerance of the feeder 110.

Furthermore, as indicated in FIG. 1, the driving mechanism 180 can continuously drive many pieces of paper P from the holder 142 to the first surface 120a, and the moved pieces of paper P′ are placed in the containing space 130 in proper order. Besides, in the present embodiment of the invention, the holder 142 is parallel to the frame 144. However, depending on the industrial or functional design of the product, the holder 142 can also be disposed at a tilt angle with respect to the frame 144. Preferably, the frame 144 is laid over the base 120 and surrounds several edges of the base 120.

Moreover, the first surface 120a of the base 120 has many ribs 120c disposed in parallel for lifting the paper P′. The ribs 120c are protruded from the first surface 120a towards the holder 142, and the extending direction of the ribs 120c is parallel to the moving direction of the paper P driven by the driving mechanism 180. Preferably, the part of the ribs 120c farther from the cover 160 is higher than the part of the ribs 120c closer to the cover 160. When the paper P′ is placed on the first surface 120a, the side of the paper P′ farther from the cover 160 is lifted away from the first surface 120a by the ribs 120c, so as to facilitate the convenience of grabbing the paper P′. The holder 142 can further have a recess 142a, via which the user can grab the paper P′, further improving the convenience of use.

Besides, the second surface 120b of the base 120 is preferably a smooth plane and is substantially white. In practical application, the entire base 120 can be made from a white material. The second surface 120b of the base 120 can lie closely on the body 190, so that the paper P″ is placed between the second surface 120b and the body 190 evenly.

In the present embodiment of the invention multifunction printer 200, the cover 160 is liftably disposed on the housing 140 and can be lifted with respect to the housing 140. The cover 160 further covers the driving mechanism 180 and prevents the driving mechanism 180 from being exposed outside the cover 160, lest the user might contact and dust or foreign objects might fall into the driving mechanism 180, and the aesthetic can be maintained. Besides, the driving mechanism 180 includes a pickup roller 182 and a paper-separating assembly 184. The pickup roller 182 disposed in the cover 160 for contacting the paper P that is placed on the holder 142 and for moving the paper P with respect to the holder 142. In the present embodiment of the invention, the pickup roller 182 is preferably a passive roller. When the cover 160 is lifted with respect to the housing 140, the multifunction printer 200 can not apply any power to the pickup roller 182, and the pickup roller 182 is in a state of free rotation. Therefore, the injury of user caused by the rotating pickup roller 182 is avoided.

In addition, the driving mechanism 180 further includes an elastic arm 183 disposed at the part of the housing 140 corresponding to the pickup roller 182. When the driving mechanism 180 drives the paper P moving, the paper P is moved between the pickup roller 182 and the elastic arm 183. The elastic arm 183 applies a force toward the pickup roller 182 for enabling the pickup roller 182 to lean against the paper P, so that the pickup roller 182 can drive the paper P smoothly. Preferably, the paper P is driven by the pickup roller 182 first and then contacts the paper-separating assembly 184 for paper separating. The paper-separating assembly 184 contacts the two surfaces of the paper P. When the paper P is moving, the paper-separating assembly 184 provides the friction of opposite directions to the two surfaces of the paper P.

More specifically, the paper-separating assembly 184 includes a paper-separating roller 184a and a paper-separating element 184b. The paper-separating roller 184a is disposed in the cover 160, and rotates simultaneously with the pickup roller 182. The paper-separating element 184b is disposed at the part of the housing 140 corresponding to the paper-separating roller 184a. When the paper P passes through the paper-separating assembly 184, the paper-separating roller 184a and the paper-separating element 184b respectively contact the top and the bottom surfaces of the paper P, and provide the friction of opposite directions to the paper P. When the pickup roller 182 drives more than one piece of paper P, the paper-separating assembly 184 separates these pieces of paper P to assure that the feeder 110 only feeds one piece of paper P at a time.

The body 190 of the multifunction printer 200 at least includes a transparent plate 192, a scanning module 194, a communication module 197, a printing module 198 and a casing 196. The scanning element 194 is movably disposed in the casing 196. The top surface of the casing 196 exposes the transparent plate 192. The feeder 110 is preferably liftably disposed on the body 190, and the second surface 120b of the base 120 is evenly contacted with the transparent plate 192. After the feeder 110 is lifted with respect to the body 190, the paper P″ is then manually placed on the transparent plate 192. Next, the feeder 100 is brought back to cover the body 190, making the base 120 evenly press the paper P″, so that the scanning module 194 can scan the paper P″. In practical application, the scanning module 194 moves from one side closer to the cover 160 to the other side farther from the cover 160. The communication module 197 is used for receiving and transmitting data, and the printing module 198 is used for printing data. The multifunction printer 200 integrates the scanning module 194, the communication module 197 and the printing module 198, and is able to make copies, send or receive a facsimile.

On the other hand, the driving mechanism 180 further includes a scanning roller 186 and many passive rollers 188. The cover 160 is laid over the scanning roller 186 and the passive rollers 188. When the pickup roller 182 drives the paper P moving, the scanning roller 186 and the passive rollers 188 guide the paper P to pass over a light-sensing region 196a of the casing 196, and then guide the paper P to move to the first surface 120a. The light-sensing region 196a is located underneath the scanning roller 186 for example. When the scanning module 194 is positioned under the photo-sensing region 196a, the paper P passing over the photo-sensing region 196a can be scanned. Thus, the multifunction printer 200 can automatically feed the paper P through the feeder 110 and perform scanning.

In the feeder and the multifunction printer using the same disclosed in the above-described embodiment of the invention, since the frame need not contain the paper, after the piece of paper is driven by the driving mechanism, the paper can pass through the opening of the frame and can directly settle on the first surface of the base. Compared with conventional multifunction printer, the frame with the opening in the multifunction printer of the embodiment of the invention has relative low material cost. Moreover, because the base is able to support one piece of paper and press another piece of paper on the body at the same time, there is no need to additionally dispose any paper-pressing element under the base. As a result, the quantity of elements of the feeder is effectively reduced, the structural design of the multifunction printer is relatively simplified, the labor and cost for assembling the elements are reduced, and the assembly tolerance is also effectively decreased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A feeder for moving a piece of paper, comprising:
a base having a first surface for supporting the paper;
a housing, comprising:
a frame disposed over the base, wherein the frame has an opening that exposes part of the first surface; and
a holder for holding the paper, wherein the holder is disposed over the frame, and a containing space is formed between the holder and the first surface;
a cover laid over one side of the housing; and
a driving mechanism for driving the paper, such that the paper is moved from the holder to the first surface.

2. The feeder according to claim 1, wherein the frame and the holder are integrally formed in one piece.

3. The feeder according to claim 1, wherein the frame surrounds a plurality of edges of the base.

4. The feeder according to claim 1, wherein the first surface has a plurality of ribs disposed in parallel for lifting the paper.

5. The feeder according to claim 1, wherein the base further has a second surface opposite to the first surface, the second surface is a plane and is substantially white.

6. The feeder according to claim 1, wherein the driving mechanism comprises
a pickup roller disposed in the cover for contacting the paper placed on the holder and driving the paper to move with respect to the holder.

7. The feeder according to claim 6, wherein the driving mechanism further comprises:
a paper-separating assembly for contacting two surfaces of the paper, wherein when the pickup roller drives the paper moving, the paper-separating assembly provides the friction of opposite directions to the two surfaces of the paper.

8. The feeder according to claim 7, wherein the paper-separating assembly comprises:
a paper-separating roller disposed in the cover, wherein the paper-separating roller rotates simultaneously with the pickup roller; and
a paper-separating element disposed at the part of the housing corresponding to the paper-sorting roller.

9. The feeder according to claim 6, wherein the cover is liftably disposed on the housing, and when the cover is lifted with respect to the housing, the pickup roller is in a state of free rotation.

10. A multifunction printer (MFP), comprising:
a body; and
a feeder for moving a piece of paper, comprising:
a base disposed on the body, wherein the base has a first surface for supporting the paper;
a housing, comprising:
a frame disposed over the base, wherein the frame has an opening that exposes part of the first surface; and
a holder for holding the paper, wherein the holder is disposed over the frame, and a containing space is formed between the holder and the first surface;
a cover laid over one side of the housing; and
a driving mechanism for driving the paper, such that the paper is moved from the holder to the first surface.

11. The multifunction printer according to claim 10, wherein the frame and the holder are integrally formed in one piece.

12. The multifunction printer according to claim 10, wherein the frame surrounds a plurality of edges of the base.

13. The multifunction printer according to claim 10, wherein the first surface has a plurality of ribs disposed in parallel for lifting the paper.

14. The multifunction printer according to claim 10, wherein the base further has a second surface opposite to the first surface, the second surface is a plane and is substantially white.

15. The multifunction printer according to claim 10, wherein the driving mechanism comprises:
a pickup roller disposed in the cover for contacting the paper placed on the holder and driving the paper to move with respect to the holder.

16. The multifunction printer according to claim 15, wherein the driving mechanism further comprises:
a paper-separating assembly for contacting two surfaces of the paper, wherein when the pickup roller drives the paper moving, the paper-separating assembly provides the friction of opposite directions to the two surfaces of the paper.

17. The multifunction printer according to claim 16, wherein the paper-separating assembly comprises:
a paper-separating roller disposed in the cover, wherein the paper-separating roller rotates simultaneously with the pickup roller; and
a paper-separating element disposed at the part of the housing corresponding to the paper-separating roller.

18. The multifunction printer according to claim 15, wherein the cover is liftably disposed on the housing, and when the cover is lifted with respect to the housing, the pickup roller is in a state of free rotation.
